(19) United States
(12) Patent Application Publication
(10) Pub. No.: US 2010/0022371 A1
(43) Pub. Date: Jan. 28, 2010

(54) METHOD FOR PRODUCING A ROLLER BODY AND ROLLER BODY

(76) Inventors: Heinz-Michael Zaoralek, Koenigsbronn (DE); Ulrich Severing, Kirchheim/Ries (DE); Lutz Krodel-Teuchert, Camburg/Saale (DE)

Correspondence Address: RATNERPRESTIA, P.O. BOX 980, VALLEY FORGE, PA, 19482, US

(21) Appl. No.: 12/441,048

(22) PCT Filed: Sep. 12, 2007
(86) PCT No.: PCT/EP07/07949

§ 371 Date: Sep. 15, 2009

(30) Foreign Application Priority Data
Sep. 12, 2006 (DE) 10-2006-042-752.1

(51) Int. Cl. F16C 13/00; B23K 31/02

(52) U.S. Cl. 492/40; 219/61

(57) ABSTRACT

A method for manufacturing a roller body, wherein pipe sections, each made of steel having a carbon equivalent of at least 0.45 and a wall thickness of at least 130 mm each are arranged axially next to each other and connected to each other by means of electron-beam welding.

This application is the U.S. national phase application of PCT International Application No. PCT/EP2007/007949, filed Sep. 12, 2007, which claims priority to German Patent Application No. DE102006042752.1, filed Sep. 12, 2006, the contents of such applications being incorporated by reference herein in their entirety.

### BACKGROUND OF THE INVENTION

1. Technical Field

The invention relates to a method for manufacturing a roller body for further processing into a roller and to a roller body as a component of a roller or for manufacturing a roller for treating a web-shaped medium by means of applying pressure and/or temperature, preferably for manufacturing paper.

2. Description of the Related Art

Rollers for treating web-shaped media—in particular, for smoothing paper—are increasingly manufactured using bodies made of forged steel which has to exhibit a certain minimum hardness of its surface for particular applications and types of paper. The reason for this is thermal and mechanical stresses which have increased with developments in machine speeds and smoothing techniques. A hard surface ensures a certain wear-resistance and resists indentation markings when hard particles pass the roller gap.

In the case of large paper machines in particular, acquisition problems for such forged bodies arise again and again. They can have finished diameters of up to 1.5 m and body lengths over 11 m and weigh more than 150 t in mass. At this length, hollow-forging over a mandrel is no longer possible. The cast starting body made of steel then has a weight of more than 200 t.

Although the finished roller body, hollow-drilled with a wall thickness of about 180 mm, only then has a weight of about 50 t, it is nonetheless necessary to melt and repeatedly heat more than 200 t for the forging process. The energy losses therefore represent a significant cost factor, in addition to the low net output of about 25%.

In addition, the number of forges which can handle such weights is very limited globally. They are booked up for years in advance by the demand from the energy sector for turbine and generator shafts, because the additional building of new power plants is planned over the longer term. In the case of a paper machine, it is possible for less than 18 months to pass between ordering and commissioning, which is significantly less than the delivery time for large rollers, based on the delivery time for large forged bodies.

Depending on the locations of the forges and the roller manufacturers, heavy-load transports and abnormal-load transports are also incurred, which ultimately make the roller more expensive.

With regard to the prior art, reference may be made to DE 20 2006 005 604 U1, in which a thermal treatment roller is described which consists of parts which are connected to each other and into which medium channels have already been introduced. For high heating outputs, the medium channels can therefore be introduced near to the surface. Because the parts are short, the medium channels can for example be introduced by drilling using very small profiles, which greatly homogenises the surface temperatures which can be achieved. The roller shell parts fitted with medium channels in this way are to be connected to each other by welding.

### SUMMARY OF THE INVENTION

It is an object of the invention to manufacture large rollers made of steel which is suitable for manufacturing rollers, preferably forged steel, in a more cost-effective way than by means of the present original-moulding or reshaping methods and subsequent machining processes, and to shorten the delivery times.

The object is solved by initially producing shorter pipe or roller sections. The pipe or roller sections are formed individually. They can in particular consist of cast steel, rolled steel or particularly preferably forged steel. Correspondingly, the pipe or roller sections are separately formed, for example in an original-moulding method such as casting (cast steel) or a reshaping method such as forging (forged parts). The steel alloys which are preferred in accordance with the invention exhibit improved mechanical characteristics as compared to the casting materials hitherto typical for rollers. It has surprisingly been shown that in accordance with the invention, the more highly carbonated steels used—having a carbon equivalent of at least 0.45—can be joined to a high quality by means of electron-beam welding at the wall thicknesses—typically, at least 130 mm—of the magnitude of web-processing rollers. The joined roller body has an outer diameter of at least 500 mm and an axial length of at least 6 m, wherein the advantages of joining in accordance with the invention increase at larger diameters and lengths. The outer diameter can thus perfectly well measure up to 2,000 mm or even more. Heterogeneous materials can also be connected to each other by means of electron-beam welding. Correspondingly, the invention is not restricted to the joining of pipe sections made of respectively homogenous materials.

Three pipe sections can for example be forged for the roller having a length of about 11 m, as described above by way of example. Since they only have to be about 3.7 m long, it is possible to hollow-forge the sections over a mandrel. Each of these roller or pipe sections only weighs about 18 t and can be manufactured from a block having a starting weight of about 25 t. There are therefore many more forges available which are capable of forging such shorter roller sections. Their facilities can be much lighter, and it is thus not surprising if the three sections can be provided at much lower cost than a corresponding forged part from one piece. The delivery times for smaller parts are also more favourable than those for a large part. In 2006, the ratio of delivery times was about 20 weeks to 60 weeks for large forged bodies. The numbers cited by way of the example apply correspondingly to rollers which are dimensioned differently. Forging over a mandrel represents a particularly preferred reshaping variant for forming the pipe or roller sections. The ability to use cast steel sections or rolled steel sections further increases availability, since not only forges but also other suppliers are then available.

Forged steels having a so-called carbon equivalent of >0.44, which is required in order to increase the hardness of the roller surface to ≧400 HV, have not yet been welded as thick-walled pipe bodies in the dimensions and wall thicknesses of >130 mm, preferably >150 mm, under discussion, because they are considered to be unweldable or only unweldable with great difficulty even in thinner wall thicknesses.

The thick-walled pipe sections, made of steel which is difficult or impossible to weld and which exhibits a carbon equivalent of at least 0.45, preferably at least 0.6, are metallurgically connected to each other in accordance with the invention by means of an electron beam of sufficient output before being further processed. To this end, the pipe sections are positioned relative to each other in a joining position, preferably with their front-facing sides pressed against each other, and welded to each other in a vacuum chamber. The electron-beam device can be arranged stationary during the welding process, and the pipe sections which are fixed relative to each other in the joining position can be rotated about their common central longitudinal axis. Alternatively, the pipe sections can be stationary and the electron-beam device can be moved in the circumferential direction about the central longitudinal axis of the pipe sections. Although less preferred, it is ultimately also possible for the pipe sections to be rotated about the central longitudinal axis and the electron-beam welding device to simultaneously be moved in the circumferential direction. The relative movement between the pipe sections situated in the joining position and the electron-beam welding device can in particular be continuous.

Welding is preferably performed from without, i.e. the electron-beam welding device faces an outer circumferential area of the pipe sections. However, it would also be possible in principle to instead weld from within. In one variant, welding is performed both from without and from within. Two or more electron-beam welding devices can be arranged in a distribution over the outer circumference or as applicable the inner circumference of the pipe sections situated in the joining position, and weld simultaneously. In principle, however, a single electron-beam welding device is sufficient.

Once the chamber has been evacuated, the regions to be connected to each other are preheated. This can for example be achieved using resistance heating elements wound around the roller sections on both sides of the intended fusion. In an equally preferred different variant, the electron-beam welding device is also used for preheating, for example by being operated at a lower output than during the welding process. When preheating by means of the welding device, the relative speed between the pipe sections situated in the joining position and the electron beam can be varied, in particular increased, as compared to the welding process. An electron beam having an output of for example about 80 kV is preferred for the welding process.

The electron beam, which is directed onto the join, preferably an abutting join, between the roller sections and flush with the same, vaporises the steel and drills itself a capillary, around which the steel melts. Once the beam has reached the required welding depth, preferably the inner drill hole and/or hollow cross-section, the pipe sections are set in a rotation about their common central longitudinal axis, preferably at a uniform rotational speed. The preferably vertical beam then melts the material which approaches it during the rotational movement and which is connected together downstream of the beam after it has passed it. Because of the small diameter of the beam, which measures between 1/10 and 2 millimetres, preferably at least 0.5 mm and at most 1.5 mm, and a rotational speed which is preferably selected from the range of 0.4 to 1.2 mm per second as measured on the outer circumference of the pipe sections and can in particular measure about 1 mm per second, the so-called heat affected zone of the fusion remains narrowly limited. The above specifications also apply if the arrangement is reversed, i.e. if the welding connection is produced with stationary pipe sections and an electron beam which is moved in the circumferential direction. Even sections made of steel having a comparatively high carbon content, for example 62CrMoV6.3 (carbon equivalent=0.69) which is preferably used for rollers in paper calenders because of its good hardenability, can be connected to each other in this way without cracks at wall thicknesses of up to 180 mm and even above this. This is achieved among other things due to fact that, unlike the typical welding methods, no additional weld deposit has to be introduced into the molten mass.

The pipe sections and subsequent roller sections to be connected to each other are preferably preheated in the region of the connecting join before being welded, preferably to a temperature of at least 150° C., more preferably to a temperature of about 400° C.

The pipe or roller body which is fused together in this way from two or a practically arbitrary number of stages or sections is preferably subjected as a whole to an annealing treatment in a furnace and then tempered, such that the changes in structure due to local melting at least substantially disappear. The body is then further processed as an ordinary forged body and further improved by for example tempering and/or inductive edge-zone hardening.

Manufacturing the pipe body composed of individual pipe sections is advantageous for pipe bodies having an outer diameter of 800 mm and upwards and an axial length of 8 m and over, i.e. of an order of magnitude such as also typically obtains in roller bodies for treating web-shaped media.

In preferred embodiments for manufacturing a roller body for a roller for treating a web-shaped medium, axial channels are formed, preferably drilled, in the welded roller body, i.e. in the shell composed of the individual axial sections, wherein a thermal treatment fluid flows through said channels when the roller is in operation. Fastening devices are preferably produced on the two front-facing sides of the roller body, for fastening a flange trunnion each. The flange trunnions serve to rotationally mount the roller and, in the preferred embodiments, as an inlet and outlet for the thermal treatment fluid.

### BRIEF DESCRIPTION OF THE DRAWINGS

An example embodiment of the invention is illustrated below on the basis of figures. Features disclosed by the example embodiment, each individually and in any combination of features, advantageously develop the subjects of the the embodiments described herein. There is shown:

FIG. 1 two pipe sections, positioned abutting against each other in a joining position, which are joined in abutment by means of electron-beam welding; and

FIG. 2 a cross-section through the abutting join of the pipe sections, as a front-facing view onto one of the two pipe sections.

### DETAILED DESCRIPTION OF THE PREFERRED EMBODIMENTS

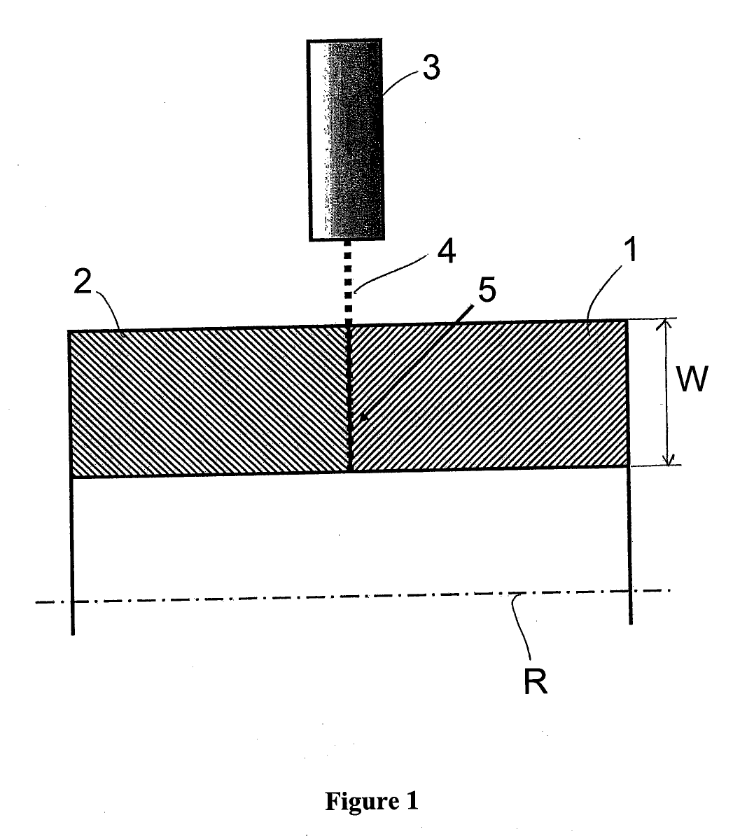

FIG. 1 shows an example embodiment of the joining in accordance with the invention of two pipe sections 1 and 2, to form a composite roller body which is intended to form a roller shell for a roller for treating a web-shaped medium by means of pressure and/or temperature. The pipe sections 1 and 2 are rotationally symmetrical. They are clamped, in a vacuum chamber, in a joining position in which they each abut the other on a front-facing side. The two mutually abutting front-facing areas form the join areas of the pipe sections 1 and 2. The abutting join formed by the mutually abutting join areas points at a right angle to a common rotational axis R of the pipe sections 1 and 2. A different orientation of the join, for example a join which is oblique with respect to the rotational axis R, is in principle possible.

For welding, the vacuum chamber is evacuated. The pipe sections 1 and 2 are heated in the region of the join to a temperature of at least 150° C., preferably to about 400° C.

An electron beam 4 is generated using an electron-beam welding device 3. During the welding process, the electron beam 4 is flush with the join, i.e. it lies in the plane of the join. The electron beam 4 exhibits a diameter of 0.5 mm and produces a melting channel or melting capillary 5, having a diameter of about 2 mm, in the region of the join. As soon as the melting channel 5 has reached the hollow cross-section of the pipe sections 1 and 2, the pipe sections 1 and 2 which are clamped in the joining position are set in a uniform rotational movement about their common central longitudinal axis—the rotational axis R—such that the electron beam 4 produces the narrow melting channel 5 in the region of the join, continuously and progressively about the rotational axis R, and the molten material of the pipe sections 1 and 2 downstream of the electron beam 4 in relation to the direction of rotation of the roller sections 1 and 2 fuses together continuously.

Electron-beam welding is particularly suitable for pipe sections 1 and 2 made of steel, and in particular forged steel, having a wall thickness W in the range of 150 to 180 mm or greater, wherein the ratio of the outer diameter to the inner diameter of the pipe sections 1 and 2 to be welded to each other should be at least 2:1, in order that the heat input into the join, i.e. along the length of the melting channel 5, is still uniform in the radial direction.

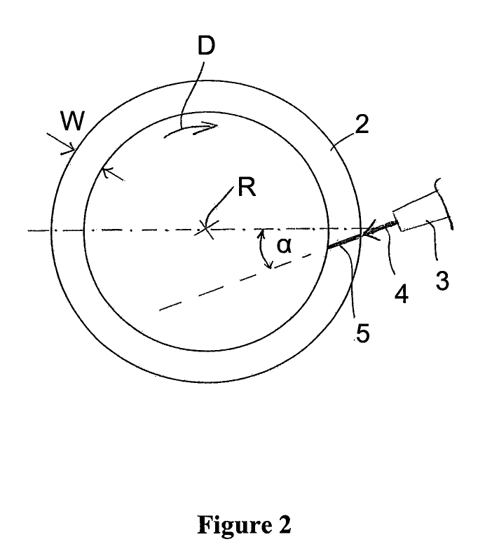

FIG. 2 shows a cross-section through the abutting join, i.e. a front-facing view onto one of the pipe sections—in the example, onto the pipe section 2. During welding, the pipe sections 1 and 2 situated in the joining position are continuously rotary-driven about the rotational axis R in the direction of rotation D. In the view selected, the direction of rotation D corresponds to the clockwise direction. The electron-beam welding device 3 is arranged and aligned such that its beam outlet is arranged facing the outer circumferential area of the pipe sections 1 and 2, approximately at the 3 o'clock position, and the electron beam 4 points obliquely at an angle α with respect to a straight line which extends from the centre of the beam outlet to the rotational axis R. Because of the positioning at the 3 o'clock position, said connecting line extends horizontally. The electron beam 4 is directed obliquely downwards at the angle α. The melting capillary 5 correspondingly runs upwards, as viewed from the inside to the outside. A weld pool backup is obtained due to the alignment of the electron beam, which is not radial in relation to the rotational axis R. The angle α measures between 15° and 25°, preferably 20°.

1-19. (canceled)

20. A method for manufacturing a roller body comprising:
arranging pipe sections, each made of steel having a carbon equivalent of at least 0.45 and a wall thickness of at least 130 mm each, next to each other; and
connecting the pipe sections to each other by means of electron-beam welding.

21. The method according to claim 20 wherein the pipe sections each exhibit a wall thickness of at least 150 mm.

22. The method according to claim 20 wherein the pipe sections each consist of steel having a carbon equivalent of at least 0.5.

23. The method according to claim 20 wherein the pipe sections are made of cast steel, rolled steel or forged steel.

24. The method according to claim 20, wherein during welding, an electron beam which welds the pipe sections to each other points at an angle of α>0° with respect to a straight line which connects a central longitudinal axis of the pipe sections and a beam outlet of an electron-beam welding device to each other, wherein the longitudinal axis forms the rotational axis of the roller body when it is subsequently in operation.

25. The method according to claim 24, wherein the angle α is less than or equal to 40°.

26. The method according to claim 24, wherein the electron beam is directed obliquely downwards during welding.

27. The method according to claim 24, wherein the beam outlet of the welding device is arranged at a location between a 2 o'clock position and a 4 o'clock position relative to the pipe sections.

28. The method according to claim 20 further comprising forming peripheral axial channels in the pipe body for circulating a liquid or gaseous heat transfer medium.

29. The method according to claim 20, wherein fastening devices for roller trunnions are produced on a left-hand front-facing side and a right-hand front-facing side of the pipe body.

30. The method according to claim 20, wherein the pipe sections are locally heated in the region of an abutting join before being welded to a temperature of at least 150° C.

31. The method according to claim 20, wherein the pipe sections are locally heated in the region of an abutting join before being welded to a temperature of 400° C.±50° C.

32. The method according to claim 20, wherein the pipe sections are locally preheated in the region of an abutting join by means of an external heating device.

33. The method according to claim 32 wherein the external heating device is induction coils or an electron-beam welding device used for the welding process.

34. The method according to claim 20, wherein the welded roller body is subjected to tempering and/or edge-zone hardening.

35 The method according to claim 20, wherein the pipe sections are welded to each other by means of one or more electron beams, and wherein the one or more electron beams each exhibit a diameter of at least 0.1 mm and at most 2 mm.

36. The method according to claim 20, wherein the pipe sections are clamped relative to each other in a joining position in which they abut each other at an abutting join, and wherein a melting channel which exhibits a diameter of at least 0.5 mm and at most 5 mm is produced in the abutting join by means of at least one electron beam.

37. The method according to claim 20, wherein the pipe sections are clamped relative to each other in a joining position, abutting each other in an abutting join; during welding, the pipe sections situated in the joining position are rotary-driven about a common longitudinal axis, or an electron-beam welding device is moved about the longitudinal axis of the pipe sections situated in the joining position, along the abutting join; and the pipe sections and an electron beam generated by the electron-beam welding device exhibit a circumferential speed relative to each other in the circumferential direction about the longitudinal axis which measures at least 0.3 mm per second and at most 2 mm per second in relation to an outer circumferential area of the pipe sections.

38. A roller body of or for a roller for treating a web-shaped medium, comprising:
a hollow-cylindrical first roller section and a hollow-cylindrical second roller section, the roller sections each made of steel having a carbon equivalent of at least 0.45 and each having a wall thickness of at least 130 mm; and
wherein the roller sections are circumferentially connected to each other by means of electron-beam welding in a join about the rotational axis of the roller body.

39. The roller body according to claim 38, wherein the welded join has a width, as measured parallel to the rotational axis, of at most 10 mm.

40. The roller body according to claim 38, wherein the roller body comprises thermal treatment channels for conveying a heat transfer medium which extend axially and are arranged in a distribution about the rotational axis.

41. The roller body according to claim 38, wherein fastening devices, each for a roller trunnion serving to rotationally mount about the rotational axis of the roller body, are provided on each of a left-hand front-facing side and a right-hand front-facing side of the roller body.

42. The roller body according to claim 38, wherein the roller body comprises a roller trunnion for rotationally mounting about the rotational axis on each of a left-hand front-facing side and a right-hand front-facing side.
